(19) United States
(12) Patent Application Publication
(10) Pub. No.: US 2006/0188239 A1
(43) Pub. Date: Aug. 24, 2006

(54) Garment steamer with standby heater

(76) Inventor: Vito James Carlucci, Stratford, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/317,412

(22) Filed: Dec. 22, 2005

Related U.S. Application Data
(60) Provisional application No. 60/638,146, filed on Dec. 22, 2004.

(51) Int. Cl. A61H 33/12; D06F 75/00; F17C 7/04

(52) U.S. Cl. 392/403

(57) ABSTRACT

A garment steaming device having a novel heater and heater control design for a garment steamer that features a low-powered standby setting parallel to a high powered steam setting. The invention also features a convenient switch location to activate the high-powered heater, thereby selecting and controlling the steam and the standby feature. Furthermore the clothes steamer features a retractable cord reel, which can be easily activated with a foot switch.

### CROSS-REFERENCE TO RELATED APPLICATIONS

This application claims priority to U.S. Provisional Patent Application Ser. No. 60/638,146 filed on Dec. 22, 2004, incorporated herein by reference in its entirety.

### BACKGROUND OF THE INVENTION

1. Field of the Invention

The present invention relates to an electric steam generator and, more particularly, to an electric steam generator with a hose and wand, for use in removing wrinkles from garments and cloth hangings.

2. Description of Related Art

It is known in the art to provide an electrical boiler, in a reservoir fed appliance, to supply continuous steam through a flexible tube to a hand-held wand. Such prior art appliances have been used to steam the wrinkles out of garments and cloth hangings. These prior art steamers have been made with single element boilers. Also, steam has been exhausted on prior art appliances through a remote hand piece, while the heater controls have been mounted on the main housing, which has been supported on the tabletop or the floor not readily accessible to the user.

The single element boiler mechanism affords a significant problem. The application of treating wrinkled cloth to relax it requires significant steam volume and since the rate of steam production is proportional to the power input, it also requires a high Wattage input to the boiler. Prior art appliances have generally operated at a single high input level. Steam production begins after water is brought to a vigorous boil and the steam output remains high until the water level drops sufficiently to trigger the reservoir valve to introduce cold water to the boiler.

At this point the boiling stops or slows until the water can again be brought up to temperature. This interruption generally results in a cyclical output of high to low steam. It is also possible, because of the considerable thermal inertia of the high wattage inputs, to trip the controlling thermostat when the water reaches its lowest level, prior to tripping the reservoir valve. This would then require the temperature in the boiler to drop below the resetting temperature of the thermostat before the boiler could recycle on. A cycling thermostat would further lengthen the cycle of high and low steam output.

Another problem encountered in prior art garment steamers, with a large steam volume, is that the units operate continuously, even while the steam is not being used, such as between applications. There is, therefore, a significant amount of water being put into the atmosphere unnecessarily, particularly on the high steam side of the cycle. A large amount of moisture, unmanaged, can cause damage and discomfort.

There is then a need for a garment steaming appliance that can deliver consistent steam, and that also features a standby mode on demand, with a reduced volume of steam. Such an appliance should also maintain water temperature, so as to again, quickly and reliably, produce steam in large volume on demand. There is also a need for a boiler design that can deliver steam in a more even manner, reducing the commonly cyclical output.

In addition, the prior art garment steamers with controls on the main housing are inconvenient, because the hand piece and long hose allows the user to be at a distance from the controls. There is a need for a more convenient switch location in the hand piece, itself. Alternatively because the larger steam units are wheeled floor models, there is a need for switch designs that can be operated by the foot. Furthermore, because the floor models require long power cords that are unsightly and difficult to stow, there is a need for a retractable cord reel that can be mounted on the clothing steamer.

### OBJECTS OF THE INVENTION

It is an object of the present invention to provide a garment steamer that overcomes the above-mentioned shortcomings.

It is a further object of the present invention to provide a garment steamer that features a low powered standby setting parallel to a high-powered steam setting and has a convenient switch location to activate the high-powered heater thereby selecting and controlling the steam and the standby feature. These and other objects are described below or inherent with respect to the present invention.

### BRIEF SUMMARY OF THE INVENTION

The present invention is directed to a novel heater and heater control design for a garment steamer that features a low-powered standby setting parallel to a high powered steam setting. The invention also features a convenient switch location to activate the high-powered heater, thereby selecting and controlling the steam and the standby feature. Furthermore the clothes steamer features a retractable cord reel, which can be easily activated with a foot switch.

### BRIEF DESCRIPTION OF THE DRAWINGS

The present invention is more fully understood by reference to the following detailed description of an illustrative embodiment with the drawings identified below.

FIG. 1 is an illustration of a sectional plan view of the preferred embodiment of the Garment Steamer with hose and hand piece.

FIG. 2 is a sectional view of the preferred embodiment of the steamer handle with the switch controlling the heaters.

FIG. 3 is an orthographic view of the boiler.

FIG. 4 is a bottom view and two sections of the boiler.

FIG. 5 is a plan view of the alternative embodiment of a floor mounted clothing steamer showing an alternative position for a steam pause switch.

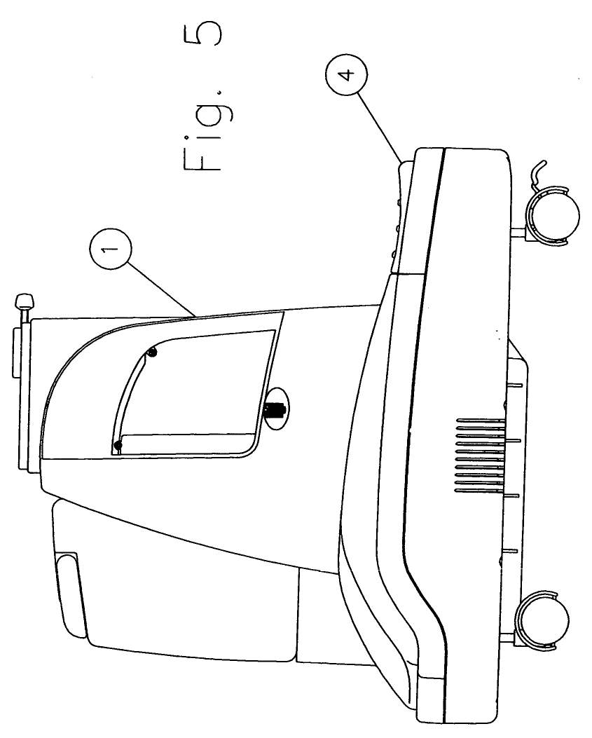

FIG. 6 is an overhead view of an alternative embodiment of a clothes steamer showing an alternative position for a steam pause switch.

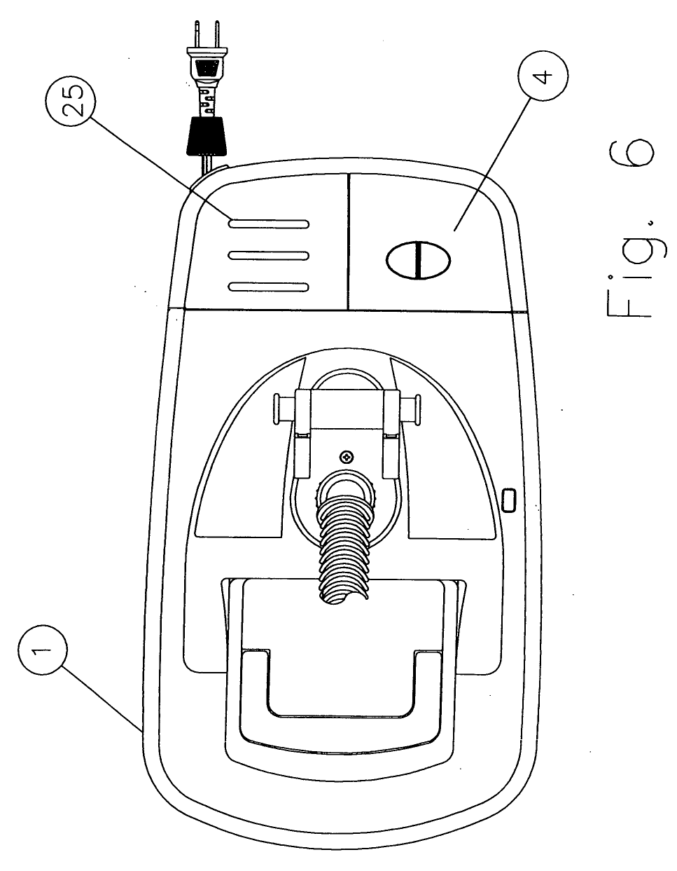

FIG. 7 is a sectional view of the cord reel and cord storage construction.

FIG. 8 is a partially sectioned view of the cord reel assembly.

FIG. 9 is an alternative circuit diagram for a relay controlled steam pause circuit.

FIG. 10 is a schematic of the circuit employed in the preferred embodiment of an improved garment steamer.

FIG. 11 is an alternative circuit employed in an improved garment steamer with switches on the main body.

FIG. 12 is an alternative circuit employed in an improved garment steamer with both main power and steam pause switch on the handle.

### DETAILED DESCRIPTION OF THE INVENTION

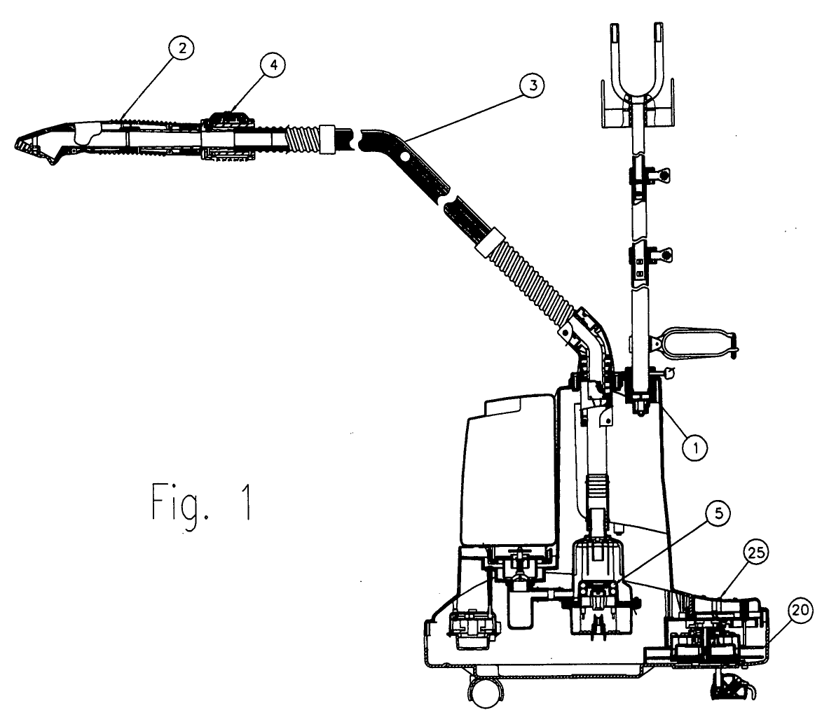

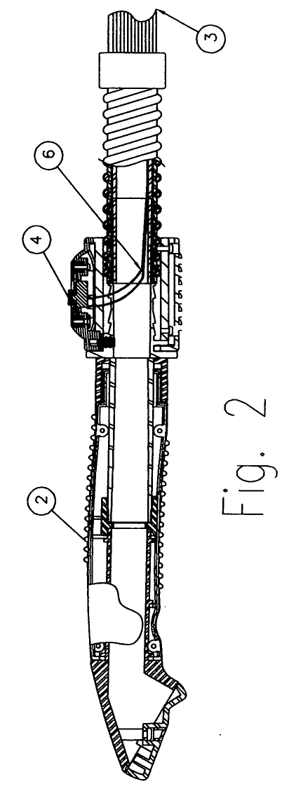

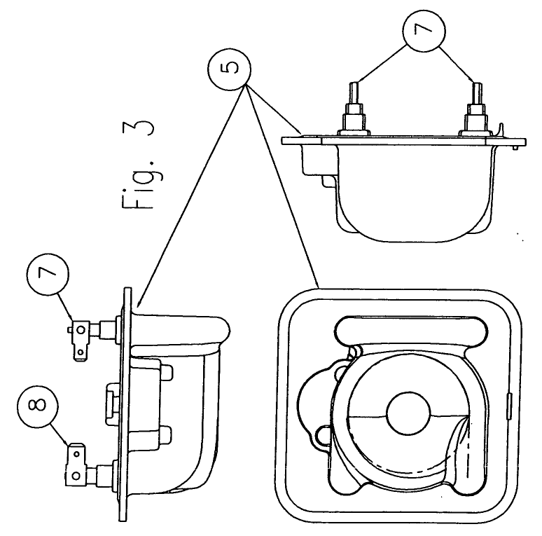

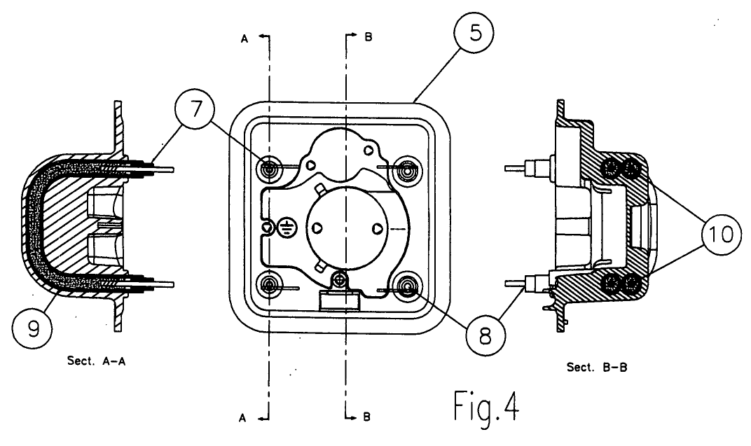

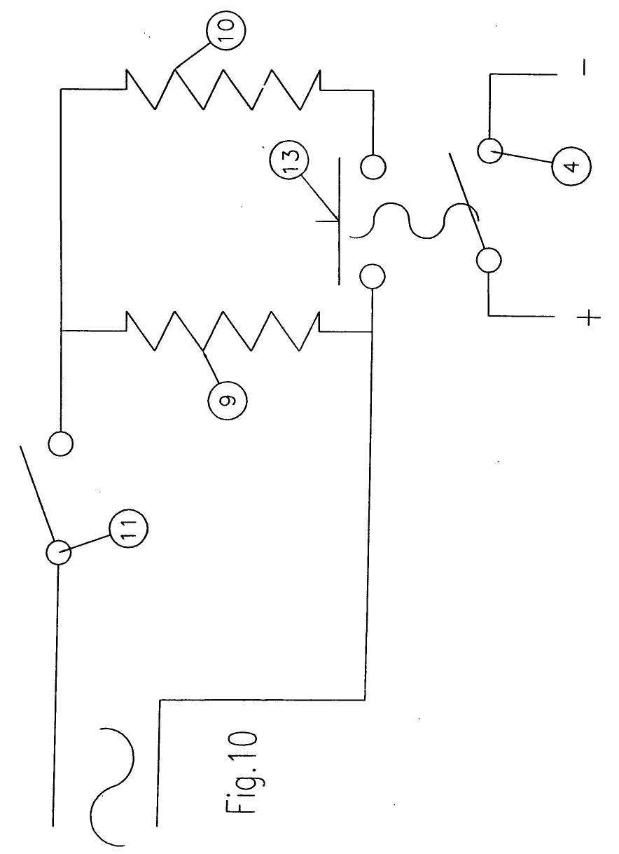

Referring to FIGS. 1 to 4, the present invention, of an improved garment steamer, is illustrated. The assembled steamer houses the boiler 5, which supplies steam thru hose 3 to the hand piece 2. At the base of the hand piece 2 is a switch 4 that switches between two pair of contacts 7, 8 on the boiler assembly 5 in order to power one or both of the heaters 9, 10 which are cast into the boiler assembly 5. The circuit diagram in FIG. 10 represents a circuit similar to that employed in the preferred embodiment. The preferred circuit switches a high-powered heater 10, (approximately 1600 Watts), via switch 4 and relay 13 and parallel to the low powered, standby, heater 9, (at approximately 200 Watts). The standby heater 9 is powered only through the primary power switch 11 on the main housing 1. The proportion between the power ratings of the two heaters will vary depending on the geometry and volume of the components.

The parallel heaters can also be controlled by separate thermostats, or alternatively with thermostatically or switch controlled relays 12, 13 or other well known arrangements of temperature sensors and controllers, such that the power is divided and controlled independently on each heater and such that heater 9 is switched out at a higher temperature than heater 10. This allows the standby heater 9 to maintain the water temperature while heater 10 is switched off. As a result the temperature recovery time to boiling is reduced. The standby heater also mitigates the fluctuations in temperature caused by the periodic additions of cold water to the boiler and improves on the cycle of high and low steam production.

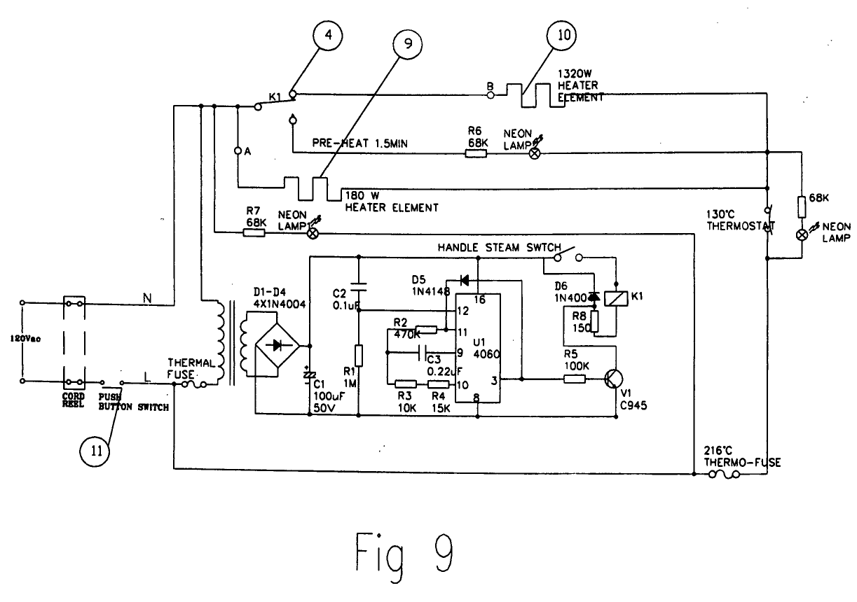

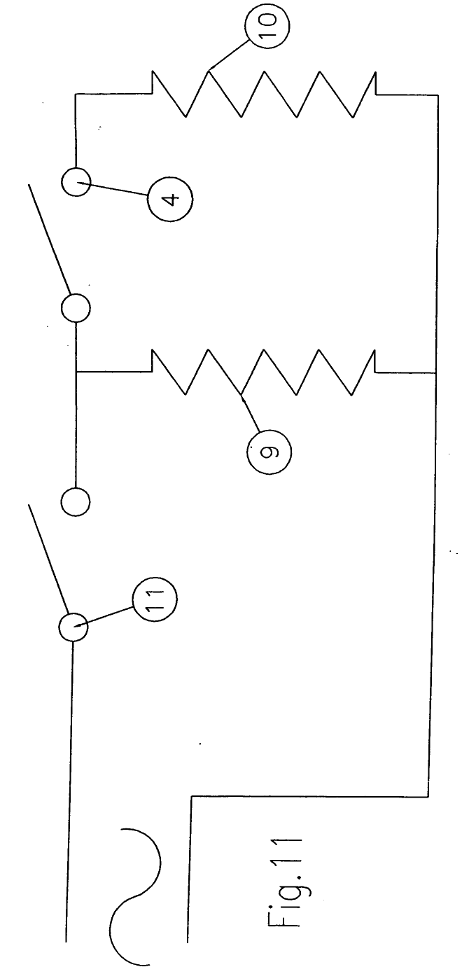

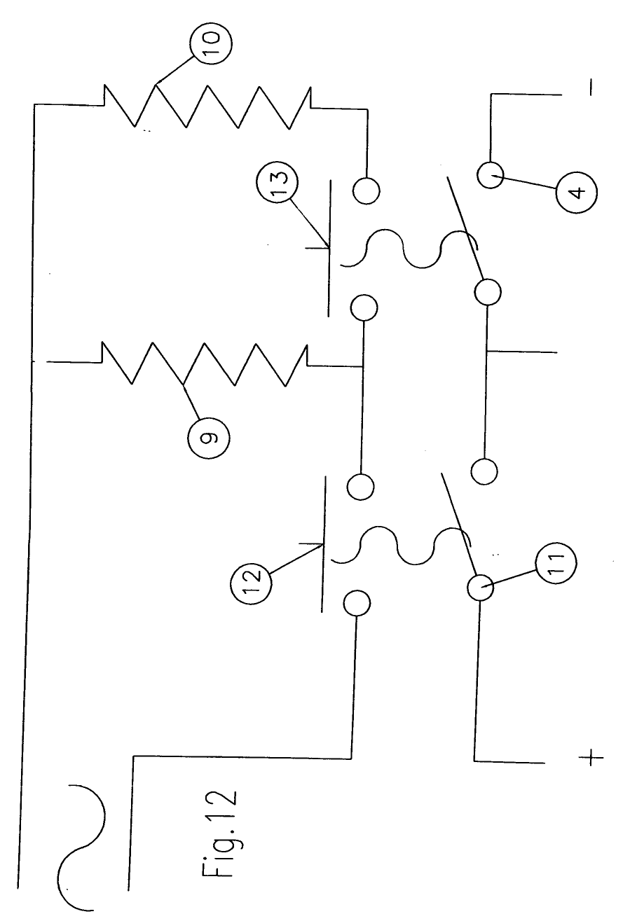

In addition, switch 4, which in the preferred embodiment is located in the hand piece 2, is employed to switch heater 10 off in order to reduce the rate of steam on demand and to maintain the appliance in a standby mode when a large volume of steam is unwanted. This feature is termed a “steam pause” switch. In the preferred embodiment, switch 4 does this indirectly by switching a power relay 13 in series with the heater 10. In an alternative embodiment, as shown in FIG. 12, the main switch 11, which powers both heaters, can also be located remotely in the hand piece to operate relay 12. In an additional alternative construction, as shown in FIG. 11, both the steam pause switch 4 and the main power switch 11 can be located on the main housing 1. The switch 4, in this alternative embodiment is designed and located on the front of the housing in order to be conveniently operated with a foot. An example of an alternative circuit design is shown in FIG. 9.

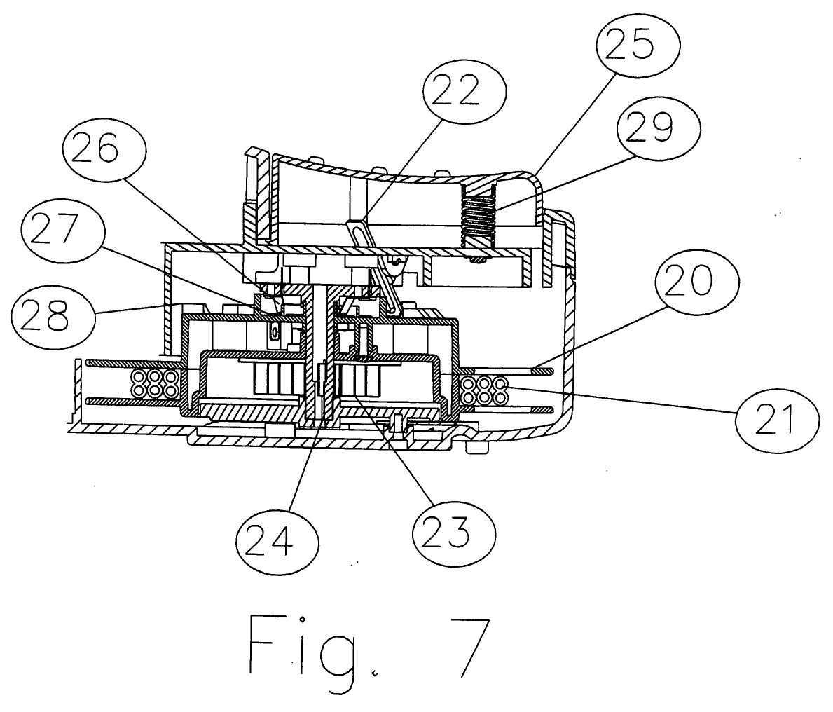

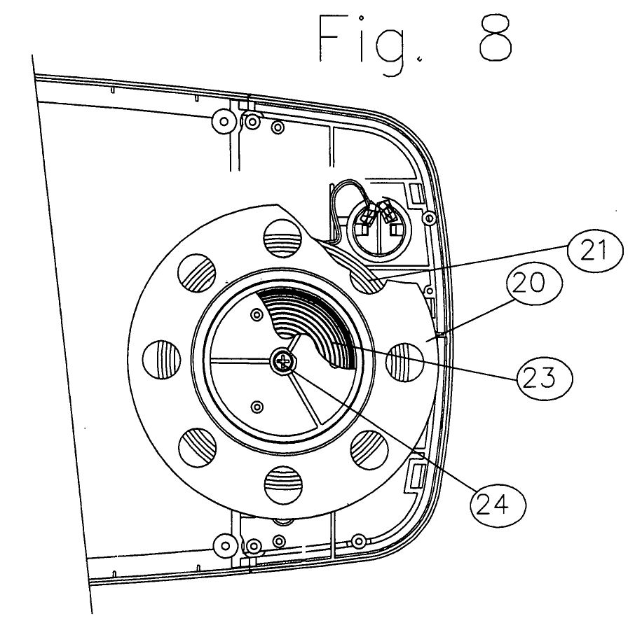

FIG. 7 is a section of the front housing of the preferred embodiment of the clothing steamer. FIG. 8 depicts a partial cut away, overhead view of the cord-reel assembly. These figures depict sections of the automatic, spring-loaded cord-reel and the cord-reel actuating switch. The reel assembly is composed of a fixed and centered, axle bearing 24 around which rotates the reel 20, upon which the power cord 21 is wound. At the center of the reel is a coil spring 23, which is wound tight as the power cord 21 is unwound. The spring 23 is housed inside the reel with one end fixed to the stationary axle 24 and the other to the rotating reel portion 20 of the assembly. The spring is kept in tension by a ratchet array 28, which is molded into the back of the rotating portion of the reel assembly 20, and which is locked in place by a spring loaded pall 22. The electrical contact between the rotating and fixed side of the assembly is made by a pair of spring contacts 26 on the fixed side, against a pair of ring contacts 27 on the rotating side. The spring-loaded pall 22 is lifted by depressing the cord reel return actuator. Depressing the actuator 25 against the coil spring 29 depresses the pall 22 and releases the cord reel to rewind on the coil spring 23. The cord return actuator 25 is designed to be depressed easily with the foot.

While a preferred embodiment of the invention has been herein disclosed and described, it is understood that various modifications can be made without departing from the scope of the invention.

What is claimed is:

1. A garment steaming device comprising:
a housing;
a reservoir within said housing for containing a liquid;
a boiler within said housing for generating steam;
a first heater;
a second heater; and
a hose in fluid communication with said boiler.

2. A garment steaming device according to claim 1, further comprising
a switch to enable a user to selectively control power to at least one of said first or second heaters.

3. A garment steaming device according to claim 2, wherein
said switch is adapted to switch between two pairs of contacts on said boiler.

4. A garment steaming device according to claim 1, further comprising
a hand piece connected to said hose.

5. A garment steaming device according to claim 1, wherein
said first heater operates at between approximately 1200 watts and 2000 watts and said second heater operates at between approximately 50 watts and 800 watts.

6. A garment steaming device according to claim 1, wherein
said first heater operates at approximately 1600 watts and said second heater operates at approximately 200 watts.

7. A garment steaming device according to claim 1, wherein
said first heater and said second heater are parallel to each other in operation.

8. A garment steaming device according to claim 4, further comprising
a first switch to enable a user to selectively control power to said first heater and a second switch to enable a user to selectively control power to said second heater, wherein said first and second heaters can be selectively controlled independently of each other.

9. A garment steaming device according to claim 8, wherein
at least one of either said first switch or said second switch are located on said hand piece.

10. A garment steaming device according to claim 8, wherein
at least one of either said first switch or said second switch are located on said housing.

11. A garment steaming device according to claim 1, further comprising
a retractable cord reel.

12. A garment steaming device according to claim 11, further comprising
a cord reel actuating switch.

13. A garment steaming device according to claim 12, wherein
said cord reel actuating switch is adapted to be operated by a user's foot.

14. A garment steaming device according to claim 11, further comprising
a coil spring to bias said cord reel toward said retracted position.

15. A garment steaming device according to claim 14, further comprising
a ratchet array to keep said spring in tension.

16. A garment steaming device according to claim 14, further comprising
a pall to temporarily lock said spring in place.
